(19) United States
(12) Patent Application Publication
(10) Pub. No.: US 2009/0272489 A1
(43) Pub. Date: Nov. 5, 2009

(54) Manufacture of Insulated Building Panels

(75) Inventors: Graeme Clark, Kingston (AU); Martin Cannon, Kingston (AU); Rodney Burnett, Kingston (AU)

Correspondence Address: Stoneman Volk Patent Group, 3770 NORTH 7TH STREET, Suite 100, PHOENIX, AZ, 85014, US

(73) Assignee: HILLENG INTERNATIONAL PTY LTD, Kingston, Queensland (AU)

(21) Appl. No.: 12/162,984

(22) PCT Filed: Jan. 30, 2007
(86) PCT No.: PCT/AU07/00082

§ 371 Date: Oct. 14, 2008

(30) Foreign Application Priority Data
Jan. 31, 2006 (AU) 2006900443

(51) Int. Cl. B32B 37/02

(52) U.S. Cl. 156/280; 156/313; 156/390

(57) ABSTRACT

A method of manufacture of an insulated structural panel which includes the step of feeding and laminating of a pair of outer skins (13, 14) and a core of insulating material (8) interposed therebetween through a press bed (7) to facilitate adhesion of an adhesive to internal surfaces of each outer skin (13, 14) and thus facilitate bonding of the core of insulating material (8) to each adjacent internal surface of each outer skin (13, 14) wherein each outer skin (13, 14) has an outer surface which is gripped by a conveyor (26, 27) having a continuous working surface in contact with each of said outer surfaces (13, 14) characterised in that said continuous working surface is formed by a coating (40, 40A, 40B) of elastomer or other synthetic polymer applied to a metal substrate. There is also provided a laminating machine (10) for use in the method as well as a track plate (37) for use in the laminating machine (10).

This invention relates to manufacture of structural insulated panels or laminated panels which normally comprise a core of insulating material sandwiched between a pair of outer skins which may include metal such as aluminium or steel. The insulating core may be relatively thick and may have a thickness of between 4 to 8 inches. Such panels are prefabricated insulated structural elements for use in building walls, ceilings, floors and roofs.

The concept of insulated building panels has been known for many years and such panels usually are connected to each other by interlocking edges such as for example, a male edge connector to be pressed into position in a groove, recess or valley in a female edge connector as shown for example in U.S. Pat. No. 5,293,729.

An alternative to this arrangement is described in U.S. Pat. No. 6,718,721 which refers to the provision of a male connector having a generally convex curved first male mating member, a generally convex curved second male mating member and a generally concave curved member between the first male mating member and the second male mating member. There was also provided on an adjacent edge of an adjoining panel a female connector complementary in shape to the male connector referred to above.

Manufacture of such insulated panels normally occurred by uncoiling opposed outer metal skins from a coil of metal and passing such metal skins together with an insulating core material in the form of a sheet between each outer metal skin into a press bed. The sheet of insulating material was normally cut and trimmed to a required size before being loaded onto a transfer table for subsequent placing or location between each of the metal skins. Prior to being passed into the press bed usually adhesive was applied to inner surfaces of each of the metal skins before each of the skins was bonded to the insulating core.

The press bed usually had a pair of conveyors supported by a conveyor frame which were separated by a gap. The panel entered the press bed through an entry end of the gap and passed out of the press bed through an exit end by which time each metal skin was firmly bonded to an adjacent outer surface of the insulating core. Each conveyor comprised a conveyor belt of articulated plates which were all pivotally attached to each other and made from steel.

It has now been ascertained that the conveyor plates as discussed above sometimes known as “CATERPILLAR PLATES” in regard to manufacture of the insulated panels was deficient in relation to use of certain insulating materials such as mineral wool. In the use of this material it is critical that the pressure applied by the steel plates be strictly controlled on opposed sides of the insulated panel. Thus if excess pressure is applied the fibres of the mineral wool will be crusted thereby causing delamination of the insulated panel.

It was also found that the use of steel plates in relation to promoting adhesion of the outer metal skins to the core insulating material was deficient in that it lacked sufficient traction to hold the insulated panel which not only meant that the grip on the metal skins was not as secure as it should be thereby causing damage to the insulated panel but it also made it difficult to achieve the critical pressures required within the press bed which were necessary with mineral wool or other insulating materials, for example, as described above.

It is therefore an object of the invention to provide a method of manufacture of insulated panels alleviating the problems described above in using bare or naked steel plates in the conveyor belts of the press bed in manufacture of insulated panels.

The invention therefore provides a method of manufacture of insulated panels which includes the step of feeding and laminating of a pair of skins and a core of insulating material interposed therebetween through a press bed to facilitate adhesion of an adhesive to internal surfaces of each outer skin and thus facilitate bonding of the core of insulating material to each adjacent internal surface of each outer skin wherein each outer skin has an outer surface which is gripped by a conveyor having a continuous working surface in contact with each of said outer surfaces characterised in that said continuous working surface is formed by a coating of elastomer or other synthetic polymer bonded to a metal substrate by a curing or baking process.

The elastomer or other synthetic polymer may be any suitable natural or synthetic rubber or may be polyisoprene rubber, polybutadrene rubber, styrene butadiene rubber, butyl rubber, acrylonitrile butadiene rubber, hydrogenated acrylonitrile rubber, ethylene propylene diene rubber, chlorobutyl rubber, bromobutyl rubber, polychloroprene rubber, chlorosulfonated polyethylene or blends of two or more of these elastomers. All these elastomers are sulphur curable.

Other elastomers that may be used are those that may be cured with peroxide type curing agents such as ethylene propylene rubber, ethylene propylene diene rubber, acrylonitrile butadiene rubber, natural rubber, fluorosilicone rubber, fluorocarbon rubber, silicon rubber, chlorinated polyethylene and flurorophosphazene rubber.

However the preferred elastomer choice in the invention is polyurethane including acrylic or polyurethane latexes and solid polyurethanes. Polyurethanes as described in U.S. Pat. Nos. 4,197,219, 5,880,167, 6,017,998 and 6,221,955 may also be used.

The methods used of applying or bonding the above-mentioned elastomer are well known in the art and are referred to for example in Polaski et al “BONDING ELASTOMERS: A REVIEW OF ADHESIVES AND PROCESSES” published by Woodhead Publishing Limited Cambridge England in 2004 which is reproduced herein by reference in its entirety.

However a representative method of applying a polyurethane elastomer to a metal substrate may include the steps of:

(i) surface preparation of the metal substrate surface which includes sandblasting and application of an organic solvent including ketones inclusive of methyl ethyl ketone;

(ii) applying a primer to the metal substrate;

(iii) application of elastomer to the metal substrate which usually involves a baking or curing process.

The primer used in step (ii) may be selected depending upon the properties of the elastomer and reference may be made to the Polaski et al 2004 publication discussed above or Polaski et al (2005) having the same title and published in RAPRA TECHNOLOGY, Volume 15, Number 9 and in Report 177. These references all describe steps (i) and (ii) in their entirety.

In relation to polyurethane elastomers, reference may be made to CHEMLOK or CHEMOSIL primers manufactured by Lond Corporation which have specific primers relevant to the type of elastomer and metal substrate. Reference also may be made to THIXON primers manufactured by Rohm and Haas.

In relation to polyurethane elastomers, the elastomer is applied to the metal substrate under high temperature and pressure and this is described in for example U.S. Pat. No. 4,948,824 wherein an assembly of elastomer and metal substrate is heated in accordance with conventional practices after being pressed together using a polyurethane adhesive if desired. If the elastomer such as a rubber in uncured and curing is to be effected during bonding the temperature may range from 140° C. to 200° C. for about 5 to 60 minutes. If the rubber or elastomer is already cured the bonding temperature may be from 90° C. to 180° C. from about 15 to 120 minutes. In using a liquid polyurethane which has already been cured, use may be made of a compression, transfer or injection mould at a relevant temperature and pressure to achieve an efficient bond.

Most preferably the polyurethane may be applied to the metal substrate in an open mould and be cured or cast onto the metal substrate having regard to the casting conditions discussed above. However it is also possible for the elastomer to be bonded to the metal substrate using an adhesive.

Reference may be made to a preferred embodiment of the invention as shown in the attached drawings wherein:

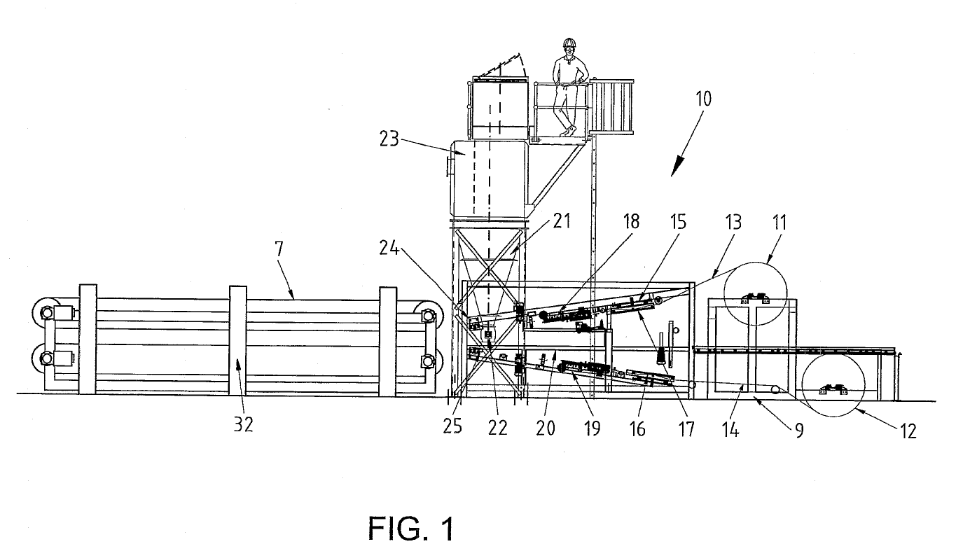

FIG. 1 is a schematic plan view of a plant for producing laminated sandwich panels with an insulated core;

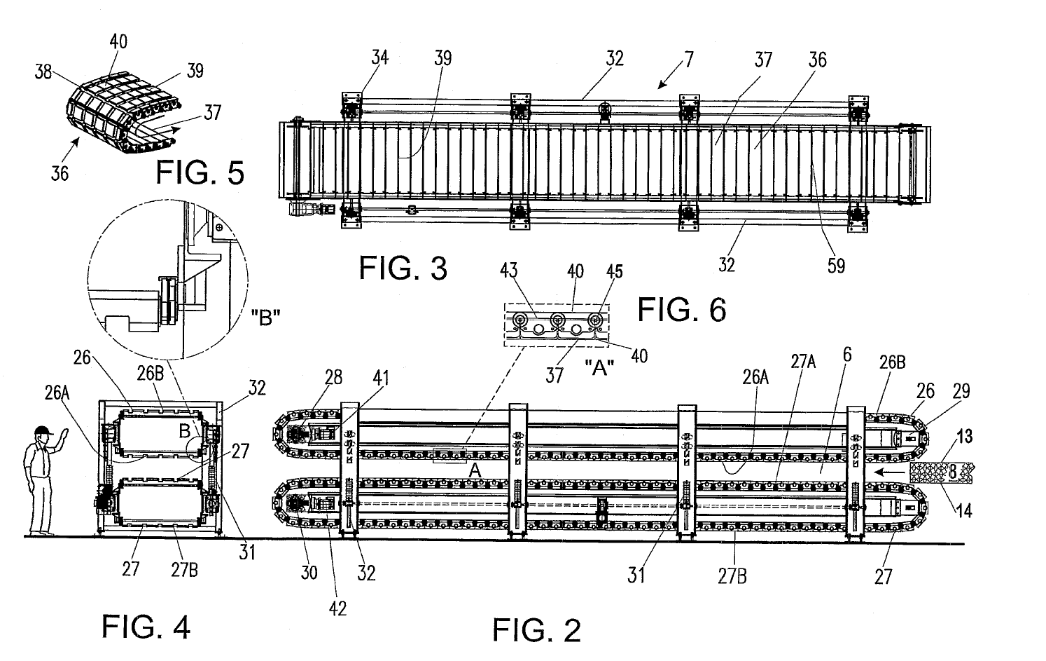

FIG. 2 is a side view of conveyor apparatus which has incorporated the steel track of the invention;

FIG. 3 is a plan view of the conveyor apparatus shown in FIG. 2;

FIG. 4 is an end view of the conveyor apparatus shown in FIGS. 2 and 3;

FIG. 5 is a perspective view of the steel track of the invention as it traverses an end of the conveyor apparatus shown in FIGS. 2 and 3;

FIG. 6 is a detail of location “A” shown in FIG. 2;

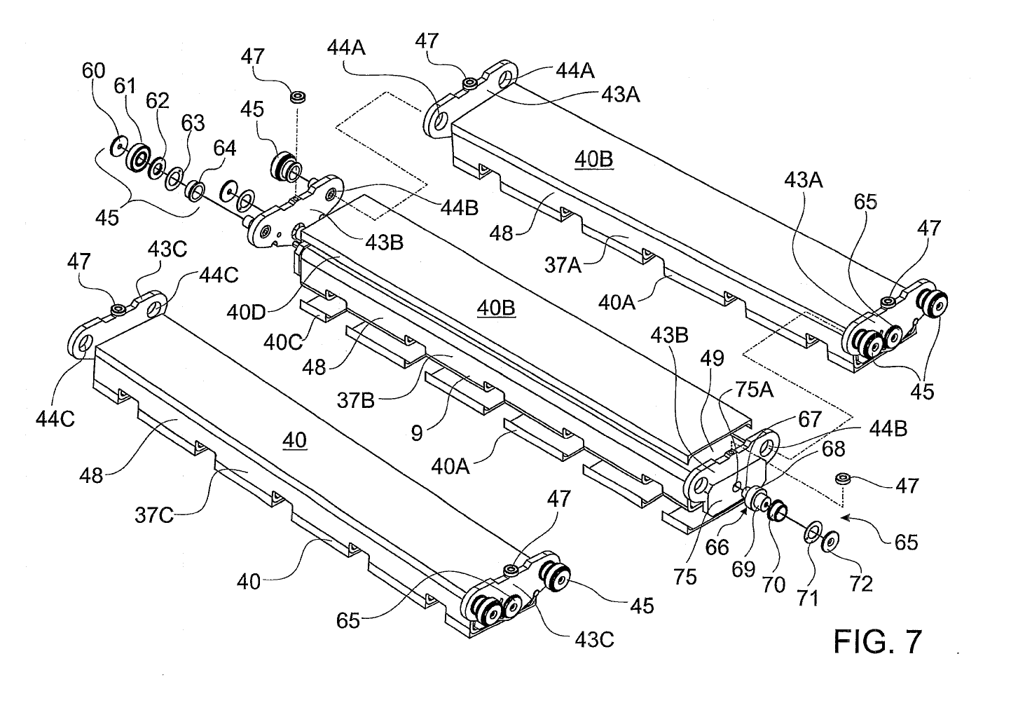

FIG. 7 is a perspective view of the three adjacent steel track plates of the invention and associated pairs of linkage plates;

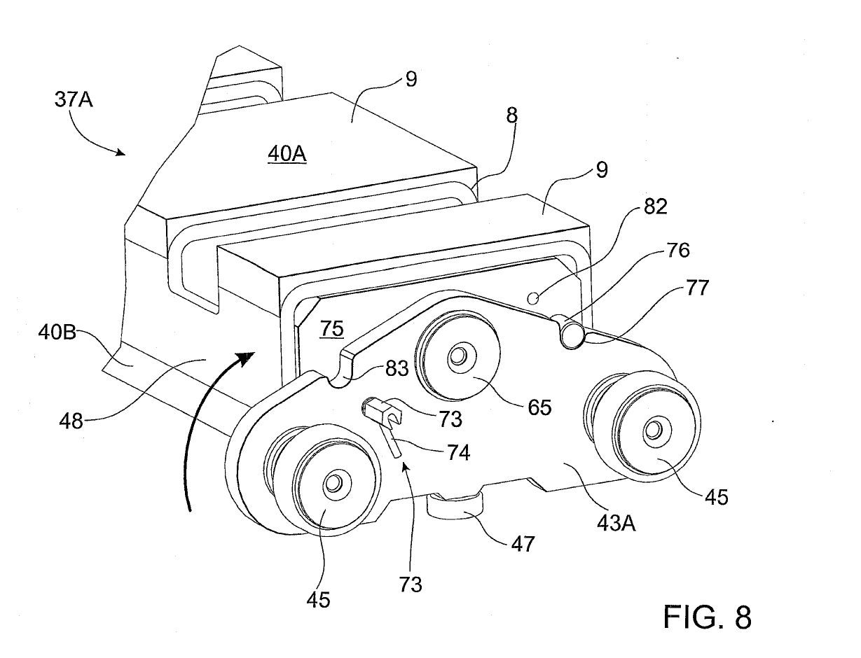

FIG. 8 is a detailed perspective view of the connection of a linkage plate to an associated end of an adjacent track plate;

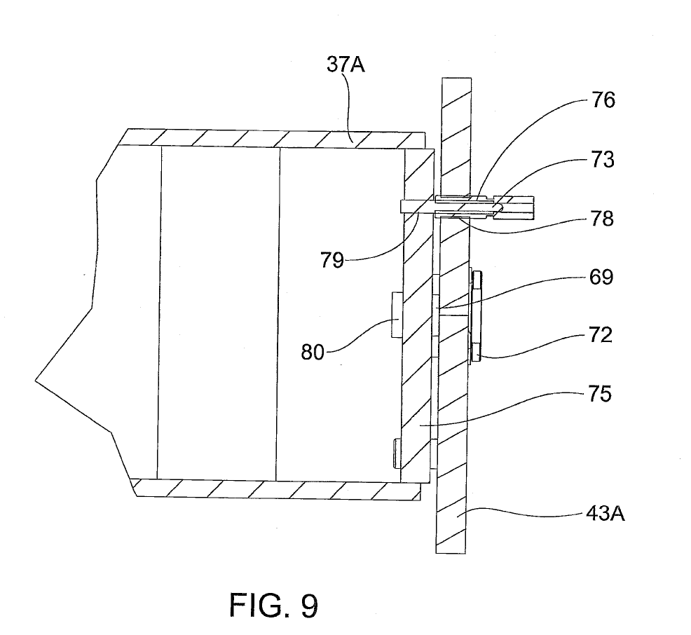

FIG. 9 is a longitudinal section through the apparatus shown in FIG. 8; and

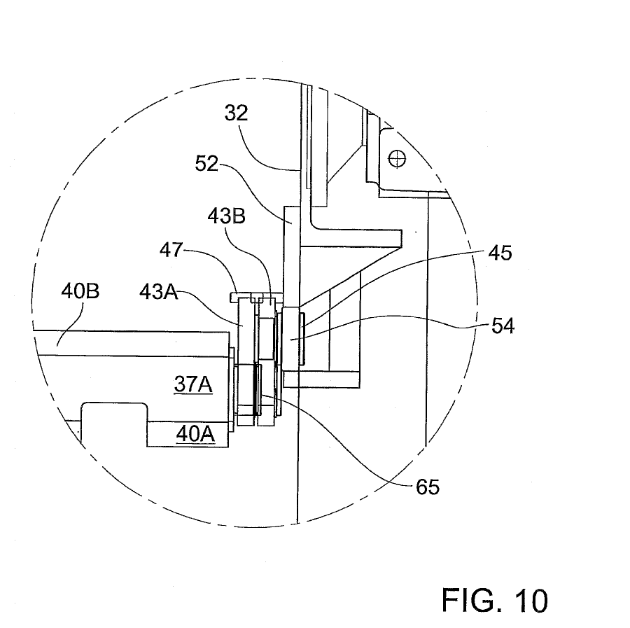

FIG. 10 is a detail “B” shown in FIG. 4.

In FIG. 1 there is shown a schematic manufacturing plant 10 for insulated building panels of the type described above where there are shown upper decoiler 11 and lower decoiler 12 each mounted on a frame 9 from which skins 13 and 14 of metal are passed through guide sections 15 and 16 where each skin is passed through rollers 17 before each skin 13 and 14 is passed through a roll forming station 18 and 19 as shown wherein a desired profile is imparted to each longitudinal edge of skins 13 and 14 to enable adjacent panels to interlock with each other as is known in the art. The core material which may include expanded polystyrene (EPS) or mineral rock wool is loaded onto central table 20 in sheets in abutting relationship and is pushed by a hydraulically actuated pusher bar (not shown) along table 20 toward press bed 7. Prior to loading onto table 20 the core material may be trimmed and excess core material or detritus is removed from table 20 by vacuum or suction through conical vessel 21 having end section 22. This waste material can be then stored in hopper 23 before disposal.

At adhesive stations 24 and 25 a two part polyurethane adhesive is imparted to the underside of both skins 13 and 14 before insertion of the panel into press bed 26 as shown in FIG. 2.

Each decoiler 11 and 12 comprises a hydraulically actuated coil mandrel and adhesive stations 24 and 25 have an upper and lower inverted slide out system. The roll formers 18 and 19 and sheet guides 15 and 16 are mounted on adjustable plates which can be manually adjusted to the desired panel width.

Thus each panel structure comprising an upper outer skin 13 and having adhesive bonded to the underside thereof and a lower outer skin 14 having adhesive bonded to a top surface thereof and an intermediate insulating core 8 is then passed onto press bed 7. This is shown by the arrows in full outline in FIG. 2 and the single arrows in FIG. 1.

The press bed is shown in detail in FIGS. 2, 3 and 4 and includes an upper conveyor 26 and lower conveyor 27. Upper skin 13 as shown in FIG. 2 contacts the lower run 26A and lower skin 14 contacts the upper run 27A to facilitate bonding of each of upper and lower skin 13 and 14 to core 8 by the adhesive. Each conveyor 26 and 27 also has an upper run 26B and a lower run 27B. There is a gap 6 which is located between each of conveyors 26 and 27. There is also provided drive roller 28 and idler roller 29 for conveyor 26 and drive roller 30 and idler roller 33 for conveyor 27.

The press bed 7 also has height adjustment jack assemblies 31 for adjusting the height of conveyor 26 relating to fixed conveyor 27 as may be required. There is also provided conveyor frame 32.

FIG. 5 shows the track 36 used for conveying skins 13 and 14 through press bed 7 which comprises a plurality of articulated plates 37 which are pivotally attached to each other at 39 so that they can move around rollers 28, 29, 30 and 33 whereby gaps 38 appear between plates 36. On each of lower run 26A and upper run 27A of upper conveyor 26 and lower conveyor 27 the plates are in abutting relationship as shown at 39 in FIGS. 3 and 5. There is also shown drive motor 41 for drive roller 28 and drive motor 42 for drive roller 30 in both FIGS. 3 and 4.

FIG. 6 shows a detail “A” of FIG. 2 and this is also illustrated in FIG. 7 and shows an elastomer 40 bonded or cast onto each of plates 37. This is also shown in FIG. 5. It will be noted that elastomer 40 is only applied to respective inner and outer surfaces of each plate 37.

FIG. 7 shows a detailed perspective view of the arrangement shown in FIG. 6 and illustrates the provision of longitudinal linkage plates 43 interconnecting each adjacent track plate 37 which are arranged in the manner shown in FIG. 7 with intermediate plate 37B having its linkage plate 43B arranged outwardly of each of plates 43A and 43C so that apertures 44B of intermediate plate 37B are aligned with apertures 44A of plate 37A as shown so that fasteners 45 may be inserted through co-aligned apertures 44B and 44A so as to interconnect plates 37A and 37B as shown. In similar manner apertures 44B of plate 37B are aligned with apertures 44C of plate 37C so as to interconnect plates 37B and 37C. Elastomer 40 is shown applied to a planar side 49 of support body 48 of each track 37A, 37B and 37C as well as to respective outer surfaces of projections 9 which are separated by slots 8.

Fasteners 45 include retaining washer 60, bearing 61, bearing support washer 62, thrust washer 63 and bearing support washer 64. Each track plate 37A, 37B and 37C is supported on a pivot assembly 65 including pivot body 66 having part 67 welded to end plate 75 of support body 48 in aperture 75A, abutment 68 and bush 69. There is also shown bearing 70, washer 71 and retaining washer 72.

In FIG. 8 reference is made to a detailed view of track plate 37A shown in an inverted configuration compared to FIG. 7 and it is evident that as shown by the arrow in full outline track plate 37A can be pivoted through 1800 when supported on central bearing 65 wherein there is provided a spring loaded locking pin 73 with handle 74 which retains track plate 37A in a fixed orientation which is also facilitated by location pin 76 engaging in recess 77 of linkage plate 43A. When it is desired to rotate track plate 37A through 180° so that elastomer sheet 40A becomes the operational working surface in contact with skins 13 or 14 locking pin 73 is withdrawn from linkage plate 43A and welded end plate 75 of track plate 37A.

FIG. 9 shows locking pin 73 and associated spring 76 engageable in co-aligned apertures 78 and 79 of linkage plate 43A and end plate 75. There is also shown track plate 37A pivotable around bush 69 which has inner retaining part 80. When locking pin 73 is withdrawn from co-aligned apertures 78 and 79 as well as locating pin 72 track plate 37A is pivoted through 180° and locking pin 73 retained in aperture 82 shown in FIG. 8 whereby surface 40B becomes the operational working surface rather than surfaces 40A as shown in FIG. 5. There is also provided recess 83 for retention of location pin 72 in this position.

There is also shown bearings 47 for each of linkage plates 43 which are attached to a mating guide bearing (not shown) to maintain alignment of each of track plates 37 as they traverse each of rollers 28, 30, 33 and 35.

FIG. 10 shows an enlarged view of detail “B” shown in FIG. 4 and illustrates part of conveyor frame 32 and stationary steel track 52 for bearings 45 of linkage plate 43A. There is also provided load bearing 54.

It will be appreciated from the foregoing that the insulated core used in manufacture of the panels may be formed from any suitable insulating material exemplified by mineral wool, expanded polystyrene, expanded polyurethane and polyisocyanurate.

It will also be appreciated that the metal substrate of the invention may comprise metal skins 0.4 mm to 0.8 mm thickness and more suitably 0.6 mm thickness. The thickness of the elastomer coating may range from 5 mm to 10 mm. Each panel may have a width of 900 mm to 1200 mm, a thickness of 35 mm to 300 mm and a length of 1500 mm to 15,000 mm.

It will also be appreciated that in the method of the invention the metal substrate will be outer surfaces of each plate 37 as shown in FIG. 6 and in particular layers of sheets 40A and 40B shown in FIG. 7 and that each individual plate 37 is subjected to a bonding or casting operation with elastomer before each of plates 37 are linked together as shown in FIG. 7 to provide a continuous working surface as shown in FIG. 3 to contact adjacent metal skins 13 and 14.

It will also be appreciated that when it is desired to make a change over in relation to manufacture of a planar structural panel that each track plate 37 will have to be reversed through 180° as described above when it approaches the end of each conveyor 26 and 27 as shown in FIG. 5. FIG. 5 shows an arrangement suitable for making profiled structural panels wherein each skin 13 and 14 will have a corrugated cross section similar to projections 9 and slots 8.

It will also be appreciated that the invention also includes within its scope (i) a plate 37 coated with elastomer 40 or 40A and 40B as well as a conveyor provided with articulated plates 37.

While the above preferred embodiment has described the metal substrate as being steel plates in the form of articulated plates 37, it also will be appreciated that the plates may be formed from other metals such as aluminium or that the metal substrate may form a continuous flexible metal belt.

It will be appreciated from the foregoing that the invention provides substantial advantages over the prior art.

1. A method of manufacture of an insulated structural panel which includes the step of feeding and laminating of a pair of outer skins and a core of insulating material interposed therebetween through a press bed to facilitate adhesion of an adhesive to internal surfaces of each outer skin and thus facilitate bonding of the core of insulating material to each adjacent internal surface of each outer skin wherein each outer skin has an outer surface which is gripped by a conveyor having a continuous working surface in contact with each of said outer surfaces characterized in that said continuous working surface is formed by a coating of elastomer or other synthetic polymer bonded to a metal substrate by a curing or baking process.

2. A method as claimed in claim 1 wherein the continuously working surface is provided by a track having a plurality of articulated track plates which abut each other when traveling in a linear direction but which separate from each other when moving around an end of the conveyor characterized in that said coating of elastomer is applied to an outer surface of each track plate.

3. A method as claimed in claim 2 wherein each track plate has an inner surface which has a corrugated shape having a plurality of projections and slots which correspond to a cross sectional shape of a profiled insulating panel characterized in that respective top surfaces of each projection has applied thereto said coating of elastomer or other synthetic polymer.

4. A method as claimed in claim 3 wherein each track plate is reversible through 180° so that said respective top surfaces of each projections form said continuous working surface.

5. A method as claimed in claim 4 wherein each track plate is reversed through 180° when it is in a location adjacent an end of the conveyor and thus traveling in a curved or non linear direction.

6. A method as claimed in claim 1 wherein the coating of elastomer or other polymer is a polyurethane elastomer.

7. A laminating machine for marking a structural insulated panel having a pair of outer skins and a core of insulating material wherein said laminating machine has an upper conveyor and lower conveyor each having a plurality of articulated track plates which abut each other when moving in a linear direction and which separate from each other when moving around an end of each conveyor characterized in that each of said track plates have an outer surface forming a continuous working surface for contacting an adjacent outer skin of said insulated panel characterized in that said working surface has a coating of elastomer bonded thereto to a metal substrate by a baking or curing process.

8. A laminating machine as claimed in claim 7 wherein each track plate has an inner surface which has a corrugated shape having a plurality of projections and slots which correspond to a cross sectional shape of a profiled insulating panel characterized in that respective top surfaces of each projection has applied thereto a coating of elastomer.

9. A laminating machine as claimed in claim 7 wherein each track plate is reversible through 180° so that said respective top surfaces of each projection form said continuous working surface.

10. A laminating machine as claimed in claim 8 wherein each track plate is reversed through 180° when it is in a location adjacent an end of the conveyor and thus traveling in a curved or non linear direction.

11. A laminating machine as claimed in any one of claims 8 or 9 wherein each track plate is attached to an adjacent linkage plate at each end thereof which has a bearing for running in a track of each conveyor wherein each track plate is pivotally mounted to each linkage plate so as to be movable through 180° when required.

12. A laminating machine as claimed in any one of claims 7 to 10 wherein the coating of elastomer or other polymer is a polyurethane.

13. A laminating machine as claimed in claim 10 wherein each track plate is locked in a stationary position relative to each track plate by a locking pin which is removed when each track plate is moved through 180°.

14. A track plate for use in a laminating machine for making an insulated panel having a metal body and a pair of outer surfaces characterized in that each of said outer surfaces is provided with a continuous coating of elastomer or other synthetic polymer bonded to the metal body by a baking or curing process.

15. A track plate as claimed in claim 14 wherein another of said outer surfaces has a corrugated shape having alternating projections and slots characterized in that each projection has a top surface coated with elastomer or other synthetic polymer.

16. A track plate as claimed in claim 15 wherein the coating of elastomer or other synthetic polymer is a polyurethane.

17. A laminating machine as claimed in claim 11 wherein the coating of elastomer or other polymer is a polyurethane.
